(19) United States
(12) Patent Application Publication
(10) Pub. No.: US 2002/0103730 A1
(43) Pub. Date: Aug. 1, 2002

(54) Computerized method and system for managing a financial capacity of a business

(76) Inventors: Peter J. Perley, Toronto (CA); Mark E. Weigel, Guelph (CA)

Correspondence Address: PIASETZKI & NENNIGER, 120 Adelaide Street West, Suite 2308, Toronto, ON, M5H 1T1, CA

(21) Appl. No.: 09/771,653

(22) Filed: Jan. 30, 2001

(51) Int. Cl. G06F 17/60

(52) U.S. Cl. 705/30; 705/33

(57) ABSTRACT

A computerized system and method of managing a financial capacity of a business having electronic records of financial accounts. The method includes the steps of providing a software system for monitoring a cash position of the business, which software system includes one or more predetermined limits defined by the financial capacity of the business. The software system is periodically connected to the electronic records to receive updated transaction information to calculate a current cash position and then calculates a cash position of the business in respect of a proposed transaction by the business. Then it calculates a permitted cash position based on the updated transaction information and one or more financial limits defined by said financial capacity. Next, it compares the calculated cash position of the business after the proposed transaction to the permitted cash position defined by the financial capacity; and provides an indication of whether the proposed transaction will cause the business to fall outside of any of the limits defined by the financial capacity. A system for implementing the method is also disclosed.

### FIELD OF THE INVENTION

This invention relates generally to the field of business management and more particularly to information systems and computerized methods to permit business managers and capital providers to more ably manage and monitor, respectively, the financial affairs of a business enterprise.

### BACKGROUND OF THE INVENTION

All business entities require capital in one form or another. Often the required capital is provided by others, either in the form of investment capital, or in the form of debt financing. In either case the capital provider has a financial interest in monitoring the financial affairs of the business on an ongoing basis. Business managers also have a need to know the financial status of their business to properly manage various aspects of the business, such as growth, receivables, debt servicing, dividend payments and the like. Boards of directors, responsible for oversight of such businesses also have a need to monitor the financial status of the enterprise to responsibly carry out their corporate governance mandate.

In the past the accounts of a business were recorded manually, and then a summary would be prepared periodically. The summary would then be periodically reviewed, for example, monthly and would also be used in response to a particular issue or situation, such as a proposed expansion, capital expenditure, bad debt or the like. At any given time there are any number of outstanding cheques which may or may not have been cashed and if cashed, not yet cleared, commitments for future purchases in terms of issued purchase orders, and the like, so the businesses' bank position lags their true cash position.

This time lag presents a problem for both the business and the capital provider. For the business manager, who reviews the status of the cash flow on the basis of recorded cheques, there may appear to be less cash in the bank than there actually is because certain cheques have not been cashed and remain outstanding. From the banks' point of view there appears to be more cash than there really is because fresh cheques may have been written and issued, but not yet presented for clearance. Thus, for both business managers and capital providers such as a lender, there is often a temporal disconnect between the state of the bank account (drawings) and what the true cash/loan position of the enterprise is.

More recently electronic books of accounts have been kept, but still these books of accounts are typically updated only periodically, for example at month end. By the time the data entry is complete, it may well be two to four weeks into the next monthly cycle, so the tabulations provided are more historical in nature than current. Even today with electronic record keeping, the availability of financial resources or the financial capacity of a business to validate fresh spending is very difficult to determine because of the time lag. This discrepancy between what a company has agreed to pay and what it has actually paid is referred to as a cash float. The size of the cash float will vary depending upon what cheques have been cashed when. This unknown float can compromise the ability of the managers to manage the business. The ability of any capital provider to protect their investment or for a board to exercise its corporate governance function is similarly compromised. Further, the cash float will typically grow in an unfavourable economic situation which will exacerbate any financial management issues at a time when the same is most critical.

Another complicating factor relates to cash flows into a business such as receipts and collections. Such receipts are somewhat unpredictable, since they depend upon the financial condition of the paying enterprise. Thus the amount of money which might be collected and thus available in the future for any proposed current transaction presents an additional uncertainty into the cash position of the enterprise since it may often be based on an unknown present cash position.

There are many forms of business information software which are used to electronically keep track of the books or accounts of a company. In addition to standard off the shelf software packages, many businesses use proprietary software uniquely developed for their particular enterprise. For a capital provider, such as a lender, assessing the risk of a loss of capital is necessary to provide a meaningful basis for assessing the fees to charge any borrower. Most lenders also have their own proprietary software, which contains the information on many borrowers. Thus, neither the lender nor the borrower will agree to provide direct access to their financial software to the other.

Thus, the most common form of communication of the financial affairs of a business to a lender is through the use of standard accounting reports which include profit/loss statements, balance sheets, aged accounts receivables reports and the like. These may be in the form of printed documents or more likely electronic documents which are developed by exporting the relevant financial information from one or more software packages into an appropriate spreadsheet. When received by a lender, typically a data entry step is required to input the borrower's information into the lender's software.

Most capital providers, such as lenders will typically impose reporting requirements to permit the lender to monitor the affairs of the business so the lender can in turn gauge the risk of losing the advanced capital. In commercial lending, the value of the lent capital exceeds the value to the lender of the lending transaction meaning that the most serious risk to the lender or capital provider is a loss of capital, rather than a loss of the account. The reporting requirements on the business can be onerous and can use up considerable precious executive and finance time because of the need to provide a specific report format. Of course, in a business downturn any reporting requirements imposed by a lender typically become even more onerous and even more executive time needs to be devoted to this issue, just when, because of other critical issues, there are even less resources available to do so.

Modern communications facilities, such as the internet, provide a potential for enhanced capability for business managers and capital providers to access and review relevant information. In the recent past various methods for improving the communication between banks and customers have been proposed. For example, PCT/US98/18934 teaches a method and apparatus for making loan applications and placing them up for bid by a plurality of potential lenders. PCT/US97/06358 teaches a real time synthetic currency network for transactions between lenders and borrowers. PCT/US00/04269 relates to an interactive point access system to permit access to conventional consumer banking services via the internet and PCT/US99/28076 relates to an electronic factoring system. However, there remains a gap between the capabilities of modern communications systems and methods and apparatus which could use such capabilities to help manage and monitor timely information relating to the financial affairs of a business enterprise.

### SUMMARY OF THE INVENTION

What is required is a method and system which will eliminate the problem imposed on a capital provider or business manager by having a cash float which can only be determined in retrospect. Preferably such a system would be easy to use and would automatically retrieve the necessary information from the electronic records of account of the business to permit the information to be completely current. Further the information should be reviewed, analysed and presented in a format which facilitates the management function of the person receiving the information, whether this is for capital management or otherwise. Further the system and method should permit a forward looking evaluation to be done to determine a future cash position of the enterprise. Thus, even if there is sufficient cash at the present, the method should determine if the proposed transaction will place the business in an undesirable cash position in the future. Further the system should be capable of interfacing many different computing platforms and yet will extract only the pertinent information.

Therefore, in accordance with a first aspect of the present invention, there is provided a computerized method of managing information relating to a financial capacity of a business having electronic records of financial accounts, the method comprising the steps of:

providing a software system for monitoring a cash position of the business, said software system including one or more predetermined limits defined by a financial capacity of the business;

permitting said software system to periodically connect to the electronic records to receive updated transaction information to calculate a current cash position;

calculating a cash position of the business in respect of a proposed transaction by the business;

calculating a permitted cash position based on said updated transaction information and one or more limits defined by said financial capacity;

comparing the cash position of the business after said proposed transaction to said permitted cash position; and

providing an indication of whether the proposed transaction will cause the business to fall outside of any limits defined by said financial capacity.

In accordance with a second aspect there is provided a computerized system for managing information relevant to a financial capacity of a business having electronic records of financial accounts, the system comprising:

a software platform for monitoring a cash position of the business, said software platform including one or more predetermined limits defined by the financial capacity of the business;

a communication connection between said software platform and said electronic records of account to permit updated transaction information to be provided to said software platform;

wherein said software platform further includes an actual cash position calculation module, a permitted cash position calculation module and a comparer to permit the two cash positions to be compared; and

a communication module for communicating whether the proposed transaction will cause the business to fall outside of any of said limits defined by said financial capacity.

### BRIEF DESCRIPTION OF THE DRAWINGS

Reference will now be made to various figures which illustrate, by way of example only, preferred embodiments of the present invention and in which:

FIG. 1 depicts an overall system architecture for implementing the present invention;

FIG. 2 shows an algorithm according to the present invention for cash disbursement creation procedures;

FIG. 3 shows an algorithm for determining available cash according to the present invention;

FIG. 4 shows an algorithm for testing a cash disbursement against other lender covenants;

FIG. 5 shows an algorithm for testing a cash disbursement against company operating criteria;

FIG. 6 shows an algorithm for determining future cash position based on a proposed transaction according to the present invention; and

FIG. 7 shows the procedures according to the present invention for issuing a supplier purchase order.

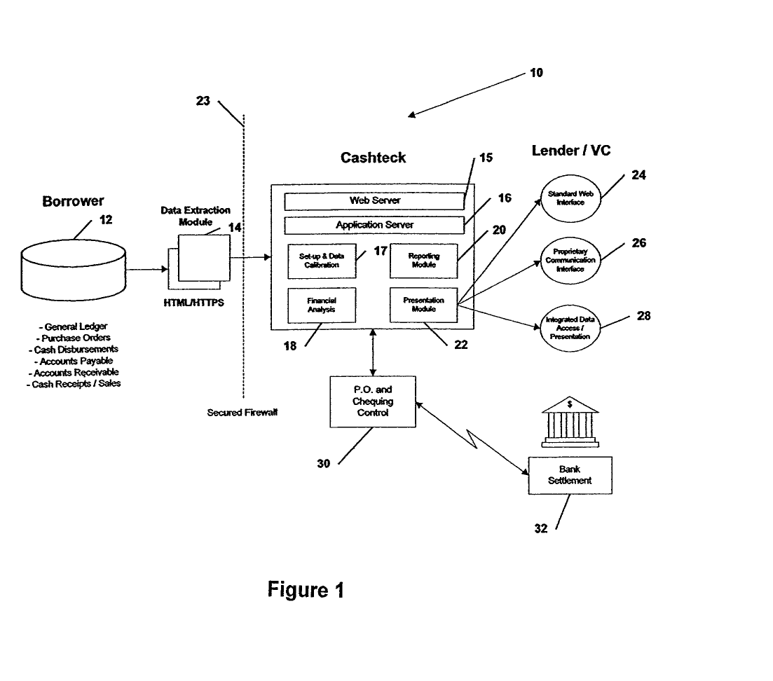

### DETAILED DESCRIPTION OF THE PREFERRED EMBODIMENTS

An architecture for implementing the present invention is depicted generally at 10. At 12 is a schematic representation of a series of electronic records of information on accounts of an enterprise which may be for example, a borrower. Included in these electronic records of accounts are such typical records as a general ledger, a record of purchase orders, cash disbursements, accounts payables, accounts receivables, cash receipts and sales and the like. The next element is a data extraction module which is indicated at 14. The data extraction module is explained in more detail below.

The next element of the architecture is a web server 15, which hosts an application server (ASP) 16 containing the financial information processing software of the present invention. It can now be appreciated that the use of an ASP is important to the present invention because while both the capital provider and the borrower or enterprise can access the information on the ASP neither is responsible either directly or indirectly for obtaining access to the others confidential financial system and thus, each are more readily able to use the system.

The ASP 16 is preferably divided into four modules. These modules include a set up and data calibration module 17, a financial analysis module 18, a reporting module 20 and a data presentation module 22. Each of these modules will be explained in more detail below. It will be appreciated that four modules are shown for ease of explanatory only; more or fewer could be used provided enough similar functionality was provided.

Between the ASP and both the capital provider such as a lender and the enterprise, it is preferred to provide a secure firewall 23. The secure firewall can be of any type known in the art and will provide a way to prevent unauthorized access to the confidential financial information by either the enterprise, the lender or capital provider or any third party hacker or the like. An aspect of the firewall is pass code or other security access.

Shown at 24, 26 and 28 are various connection options for a capital provider, such as a lender. These include, a standard web interface 24, a proprietary communication interface 26 or an integrated data access interface 28. Because of security concerns the last is the least preferred, but if security improves then it can also be used. Lastly, at 30 the output, which may be generalized as cheque and purchase order control is related to an account 32 which requires bank settlement.

In general terms the most preferred form of the present invention is for a system which is neither controlled by the capital provider nor the enterprise but is one to which they both have access through the secure firewall as shown. Most preferably the system is one having a data extraction module, which comprises a software element which is configured to enter into a businesses records database and extract relevant financial information needed to permit the system to compare the position of the enterprise after completing the proposed transaction to a permitted condition for the enterprise to see if the proposed transaction is acceptable. The present invention also comprehends, rather than a data extraction module, a export module located on the enterprises' system which will extract and export the relevant information as set out more fully below. In either case the present invention comprehends the communication of relevant information between the ASP and the enterprise and then, between the ASP and the capital provider in the event certain conditions arise. These conditions are defined in more detail below.

In this disclosure the term financial capacity is understood to be the preferred financial state of the business enterprise defined by various business measures. These measures may be set by a capital provider, such as a financial institution or bank, or may be set by the internal controls of the business enterprise itself. Examples of business measures which may be used to define a preferred financial condition include, lender covenants relating to cash flow, borrowing capacity, allowed capital expenditures, return on sales, EBITDA, net profit, directors and officers remuneration, debt service ratios, and timely payment of priority payments. In this sense a priority payment is any payment obligation of a business which ranks ahead in priority to any security of any one or more capital providers to the business. It will be appreciated by those skilled in the art that while the foregoing lists some of the most common business measures it is not intended to be exhaustive and that there are many other measures which also can be used to define a preferred financial condition for an enterprise. As will be further understood by the following description, once the preferred conditions or measures have been defined then they can be used to define a permitted cash position.

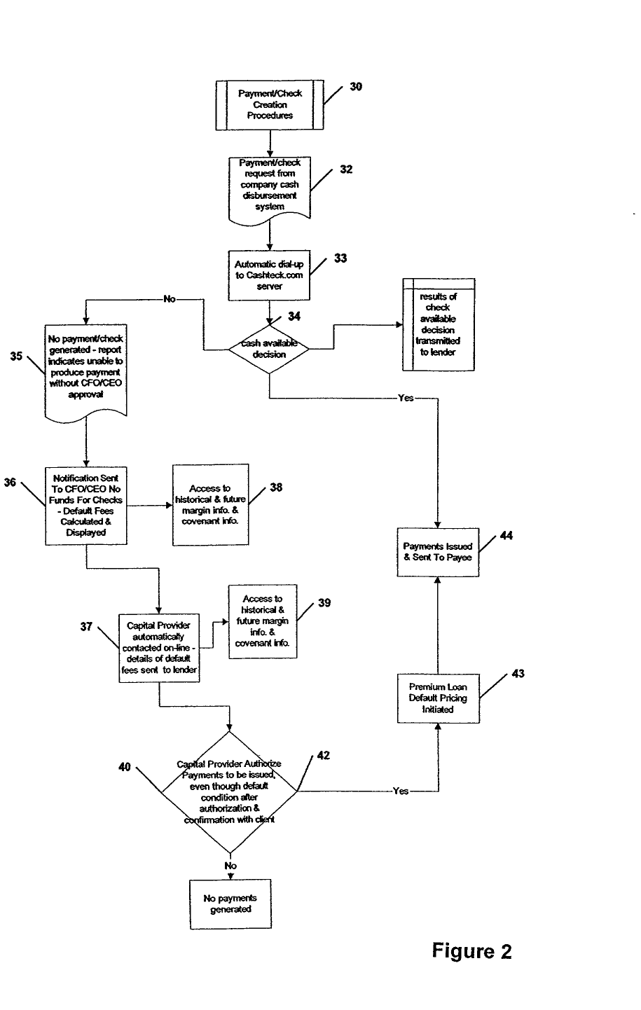

FIG. 2 shows an algorithm for the determination of whether to permit the creation of a disbursement from the company's cash flow 30. While this will typically take the form of a cheque 32, the present invention comprehends other types of disbursements such as cash withdrawals, bank drafts, and even future commitments such as purchase orders and the like. This approval procedure is initiated by a request from the business for the allocation of a cash disbursement. Such a requesttriggers an automatic dial up to the ASP 33 server to make a cash available decision, which is indicated in box 34. The actual determination of whether the cash is available is set out below.

If the cash calculation is negative, meaning the cash is not available, then the system generates a no payment report, shown at 35. Essentially this means that the system has determined that to produce the disbursement would put the enterprise outside of its preferred financial capacity, such as outside of its loan margins or preferred operating ratios. When this situation occurs, then a notice is sent 36, for example, to the CFO and anyone else who should be made aware of this issue. Most preferably the notice is sent by e-mail and would include a specific number of recipients as desired.

In the event the capital provider has made provision for such an occurrence, by for example setting up a schedule of default, overdraft or other occurrence charges, these can then be communicated to the enterprise to ensure that they are aware of the cost of proceeding with the proposed transaction. As well, this default fee information can be communicated to the capital provider 37 to allow them to identify the consequences of the out of margin position. Access to historical data can also be provided 38, 39. This is helpful to see if the default is an isolated incident or a regular occurrence.

It will be appreciated that the out of margin occurrence should not arise automatically, with the mere request for a cash transaction. However, the business executives should be advised of the appropriate lack of financial capacity and then given the option of delaying the transaction to a later date. The system most preferable though also permits an executive with sufficiently senior authority, such as a CFO or CEO to continue with the transaction, with the default consequences and the notification to the capital providers as noted previously. In the event that the default might arise, the present invention also comprehends providing to both the enterprise and the capital provider historical information relating to historical as well as to future financial capacity as explained in more detail below.

In the event the executives of the business, having received the warning that the cash disbursement will be outside of their financial capacity, and still wishes to proceed in light of the default fees, then the present invention also comprehends that the capital provider could still refuse to approve the transaction 40. Thus, according to the present invention, because of the real time communication of the potential default to the capital provider, before it is incurred, and the ability of the capital provider to determine the risk to its capital associated with such a default, then, the capital provider is in a better position to determine whether to approve the transaction and if so, whether to revise the loan covenants of the business to take into account the higher risk.

In the event the capital provider approves the expense 42, then the present invention comprehends an adjustment to the loan pricing 43, and permits the payment to be issued to the payee 44. A further aspect of the present invention is the marking of any approved cheque, before being issued, with a mark to indicate that the cheque amount is pre-approved, for example, by a lender. In this manner a recipient of the cheque will know that the cheque is approved and valid. Such a marking may take the form of a logo or printing on the cheque, or any other form of marking whether visible or otherwise on the cheque, which will represent a certificate of validity and a confirmed obligation to pay. While a cheque is generally understood as a binding obligation to pay contractually, in the event of a default the party out of pocket simply becomes another unsecured creditor. Through use of the marking of the present invention, the recipient will have the benefit of knowing, before even presenting such a cheque for clearance at their own financial institution, that the cheque will clear and be approved.

Most preferably the present invention further includes a scenario generator permitting both the enterprise and the capital provider to run some “what if” scenarios. In this sense a what if scenario is one where one or more of the underlying assumptions is changed and the financial model rerun to determine the effect of the change. In this manner the effect of what may be viewed as low probability events may be evaluated and factored into any risk assessment. For example, there might be a large receivable outstanding which is overdue at the time approval for a fresh disbursement is sought. The what if calculator will permit calculations to be made on the status of the business given various assumptions about when the receivable is collected and about how much is collected. As will be appreciated by those skilled in the art such a calculation in which the financial capacity of the business can be tested against various fact scenarios will be very useful in managing the enterprise and evaluating any capital risk. Essentially such what if scenarios will involve identical procedures and calculations except that rather than using one set of predetermined assumptions, other assumptions can be made, entered and run and the change evaluated.

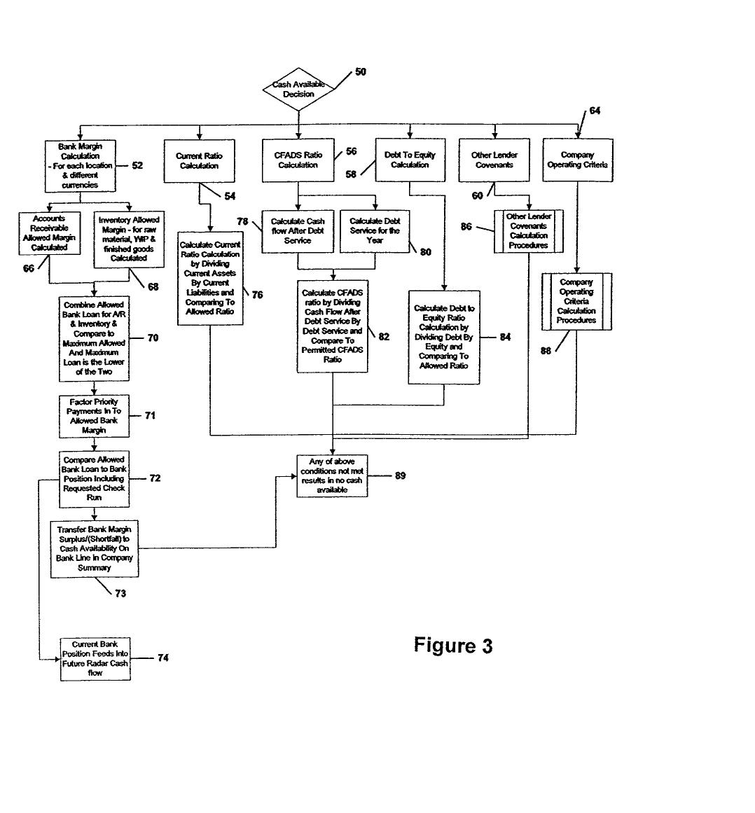

FIG. 3 shows a flow chart for one method of calculating whether the cash is available for the requested transaction. Beginning at box 50 the question posed is whether there is cash available for the proposed transaction. To answer this requires an investigation into the financial capacity of the business which involves reviewing financial data on a number of specific issues. These are set out in the next row of boxes and include, for example, a bank margin calculation 52, a current ratio calculation 54, a cash flow to debt servicing calculation 56, a debt to equity calculation 58, a consideration of any other lender covenants 60 and a comparison to the companies preferred operating criteria 64. It will be appreciated by those skilled in the art that the present invention comprehends permitting the company managers to establish a set of operating criteria which may in fact be more conservative even than those established by the capital provider. The present invention can thus be used as a preliminary warning system for the managers of the business to identify potential problems before they be come large enough to cause a default under any capital restrictions such as permitted margin, lender covenants, or the like.

As shown in FIG. 3 the bank margin calculation may be further divided into an allowed margin based on accounts receivables 66 and an inventory allowed margin 68. Then the allowed bank loan can be calculated at 70. At 71, any priority payments which the business is obligated to pay can be factored in and then the allowed bank loan can be compared to the actual bank loan to see if the proposed transaction is permitted at 72. Then the excess or surplus cash margin (if there is one) is used as a determination of the cash availability 73 for the business after the transaction. As well the current cash surplus can be used in a calculation of future cash position 74 as set out in more detail below.

As shown at 76, the current ratio can be calculated by dividing the amount of the current assets by the amount of the current liabilities and comparing the same to a predetermined allowed ratio. At 78, a calculation of cash flow after debt service (CFADS) is made and at 80, a calculation of debt service for a period, such as a year, is made. In this sense debt service includes interest plus principle. At 82, using the results from 78 and 80 a calculation of the CFADS ratio is made by dividing the cash flow after debt service by the debt service amount. This ratio is then compared to the permitted ratio. At 84 a debt to equity ratio calculation is shown which involves dividing debt by equity and comparing the result to a predetermined permitted or allowed ratio.

At 86 and 88 are shown calculation steps for other covenants or company operating procedures which may apply to the specific business in addition to the ones discussed above. Thus, it will be understood by those skilled in the art that the present invention is not limited to the specific calculations discussed above and that there are many others that can be used depending upon the specific business. However, each will be characterized as being a calculation or tabulation of a specific aspect of a financial capacity of a business which is then compared to a predetermined value which is input into the system with a view to providing financial information which may be used to manage a financial capacity of the business. Thus, 89 represents the result that one or more of the above-noted calculations identified a condition which is not met so the proposed transaction can be avoided or deferred.

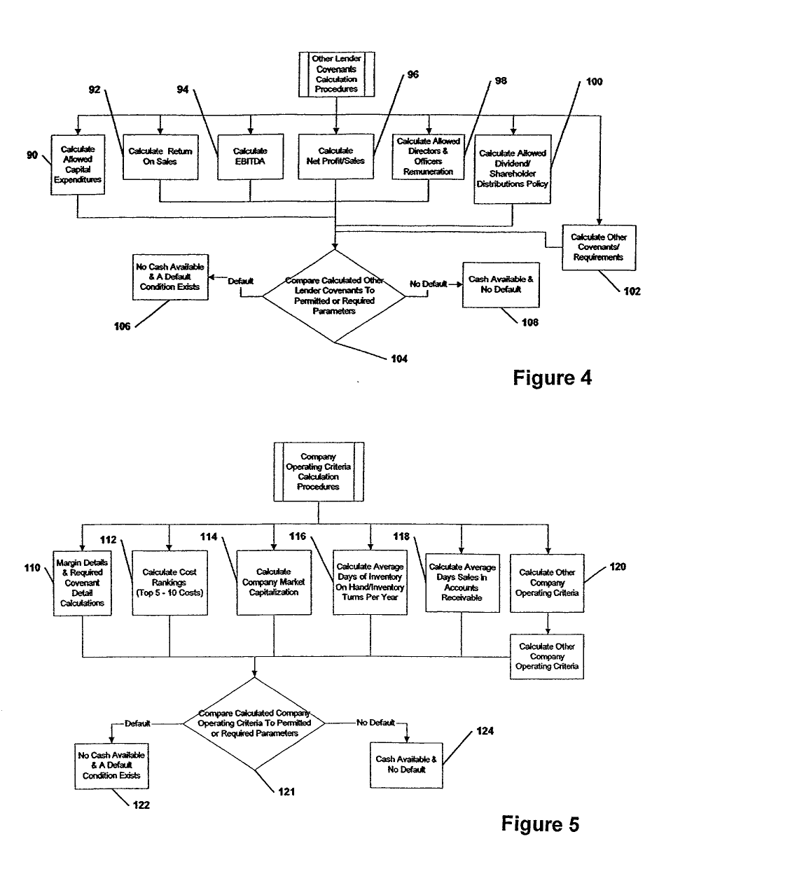

Some specific examples of lender covenant calculation procedures are set out in FIG. 4, including allowed capital expenditures 90, return on sales 92, the businesses earnings before income tax depreciation and amortization (referred to as EBITDA) 94, net profit on sales 96, allowed officers and directors remuneration 98, allowed dividend and shareholder distributions 100 and other requirements 102.

Thus, at 104 the calculated other lender covenants are compared to the permitted or required values, or if not enough cash is available, then a default condition exists at 106, and a no default if the opposite result at 108.

Some specific examples of company operating criteria calculation procedures are set out in FIG. 5. For example, the margin details and required covenant detail calculations 110, cost ranking 112, market capitalization 114, average days inventory on hand or inventory turns per year 116, average days sales in accounts receivables 118 are shown. Other company criteria are represented by box 120. As previously indicated the calculated amounts can be compared to the preset or desirable amounts and the result of the comparison shown and used by the business managers to more effectively manage the business. This is indicated by box 121. For example, if the proposed disbursement would put the company on the wrong side of one of a desired value for any specific criteria, then the proposed transaction can be disallowed at 122. Conversely, if the proposed transaction is not one which results in any form of default, then it can be allowed at 124.

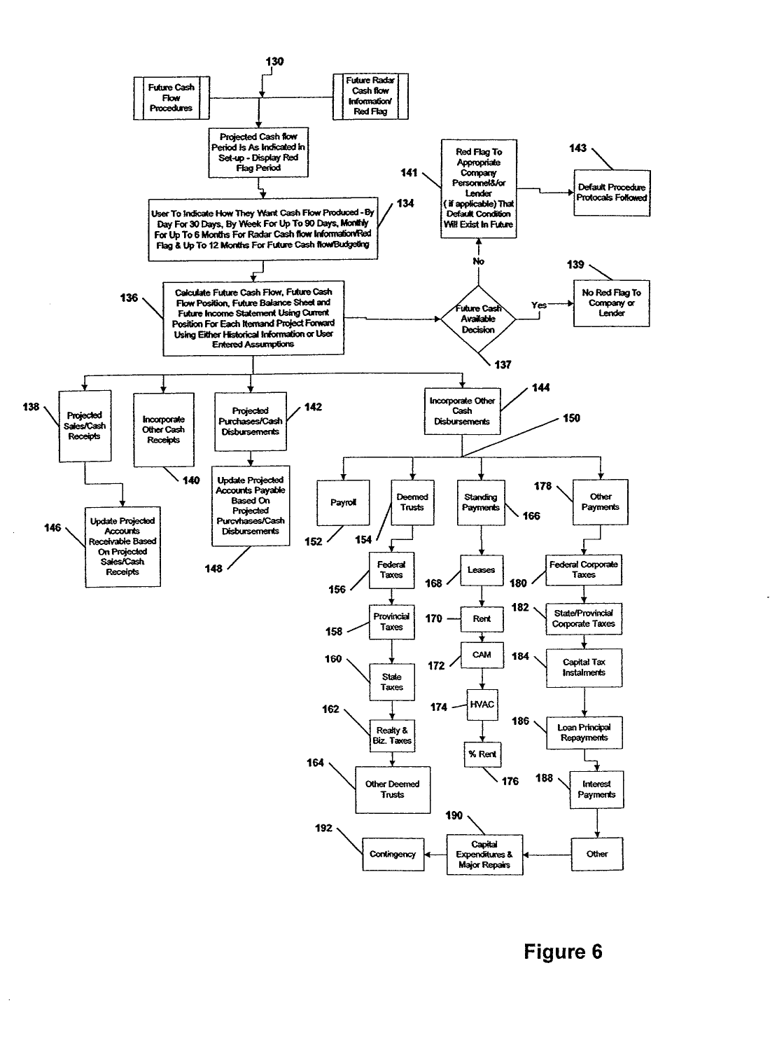

Turning now to FIG. 6, it can be seen that the present invention contemplates more than the mere identification of present conditions because it also provides for a calculation of the financial position of the business at any given point in the future. This is identified as a future cash flow calculation procedure which begins at 130. The purpose is to calculate the projected cash flow over a predetermined period to ensure that not only is the proposed transaction permitted at the moment, but that also it will not result in a problem in the future. The user is required to specify the period over which the calculation will be made, as shown at 134. Thus, the user will specify that cash flow is to be calculated for example, by day up to thirty days, by week up to 90 days, monthly for six months or some other period and frequency. Then the system will proceed with a calculation of the future cash flow. The future cash flow calculation is based on various assumptions which may be derived from historical data for the business or from assumptions about future financial conditions as estimated by the user. In addition to the future cash flow, the present invention contemplates calculation of a future cash flow position, a future balance sheet, a future income statement at 136.

The basis of the calculation is shown in more detail in FIG. 6. For example, projected sales receipts 138, other cash receipts 140, projected purchases or other cash disbursements 142 and other cash disbursements 144 are included. The projected sales receipts can be used to update projected accounts receivable at 146 and at 148 the projected accounts payable are updated based on the projected purchases.

At 150 other cash disbursements are incorporated such as payroll 152, deemed trusts 154 such as federal taxes 156, provincial taxes 158, state taxes 160 and realty and business taxes 162. There may be other deemed trusts such as may arise are indicated generally at 164. Standing payments are shown at 166, such as leases 168, rent 170, CAM 172, HVAC 174 and % rent, if any 176. Other payments 178 include federal corporate taxes 180, state/provincial taxes 182, capital tax installments 184, loan principle payment 186, interest payment 188, capital expenditures 190 and contingency funds 192.

It can now be appreciated that the system is now in a position to calculate a future cash available decision. Essentially the future cash available decision is identical to the cash available decision as described for FIG. 3, but instead of present conditions considers future conditions. Therefore the details of this calculation are not repeated here. As well the future position against the other lender covenants as well as the future position against company operating criteria can also be determined in a similar manner to that discussed above in association with FIGS. 4 and 5, with the exception that the future cash position is used in the calculations rather than the present ones. The future cash position calculation is represented by box 137. If cash is available then no red flag or alarm is generated at 139 whereas if cash is not available an alarm or alert is generated at 141 and the default protocols may be initiated at 143.

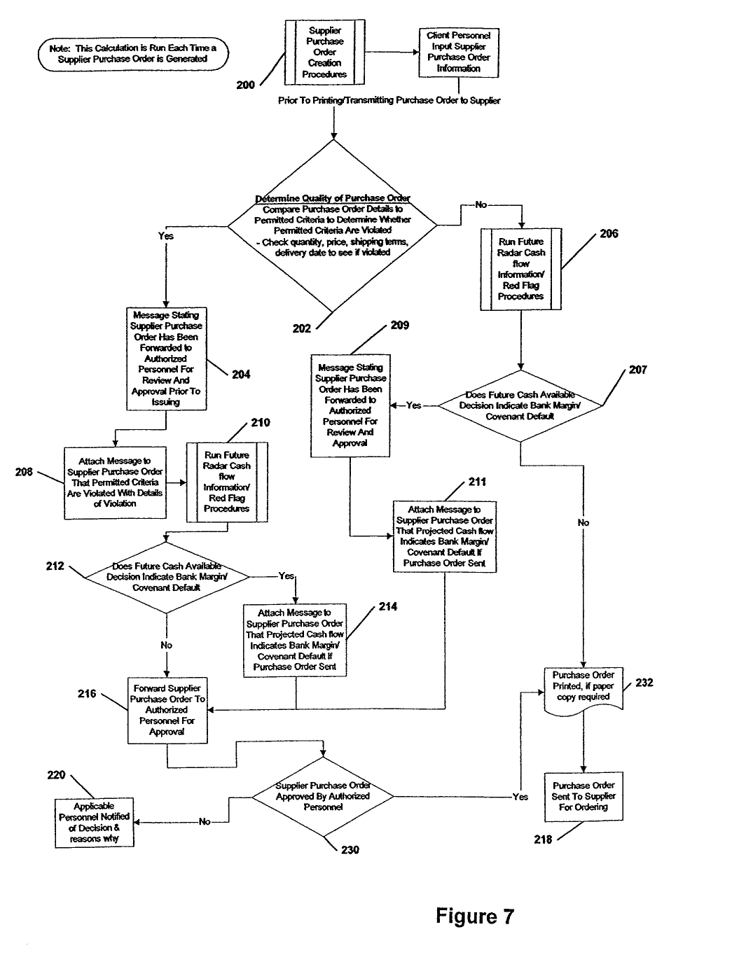

FIG. 7 shows the system algorithm for evaluating a purchase order request. As will be appreciated by those skilled in the art the issuance of a purchase order will create a legally binding obligation of the business. Thus, the executives of the business as well as the capital provider have a need to know if the purchase order can be met at the time it is issued. Thus the present invention further contemplates determining the cash position of the business in response to purchase order requests. In this case the system is initiated upon the request from the business to issue a purchase order. In this case the business personnel gains access to the ASP and will input in the relevant information about the purchase order at 200. However, prior to printing the purchase order a number of steps occur.

The first step 202 is to determine the quality of the purchase order, and thus price, quantity, shipping terms, delivery date, and whether approval is necessary can be checked. For example, the requested quantity can be checked against the extent of the current inventory and projected quantity required for the requested item. Thus, the inventory being ordered is compared with the actual inventory on hand and usage based on sales for a particular period, for example, in terms of the number of days of sales of the same. The total is then compared to the maximum allowable amount to determine if the timing of the purchase and the amount of the purchase are more than the permitted amount. If yes, the system proceeds to step 204 and if no, to step 206. Step 206 is a computational step which begins the sequence of running future cash flow information and red flag procedures.

At step 204, the user will encounter a screen or interface that indicates that the requested purchase order has been forwarded to the relevant business executive for approval, consistent with the typical approval process for purchase orders violating the permitted criteria. This communication for approval, at 208, generated by the present invention, preferably includes a summary of the inventory to assist the executive in making the decision to approve. While this example relates to inventory, it will be appreciated that any capital expenditures and/or purchase orders may be compared to preset requirements and a appropriate accompanying report prepared all of which is comprehended by the present system.

The next step at 210 is to run a future cash flow projection, to determine if even though the quality of the purchase order is acceptable whether because of pre-existing cash outflows the purchase puts the business at some margin or covenant risk. Then at 212, the system calculates whether there will be any margin default, which if yes is addressed at 214 and if no is addressed at 216. If yes at 214 then the purchase order is forwarded within the company for final approval at 216.

Turning back to step 206, once the future cash position is calculated then a decision is made at step 207 as to whether the proposed transaction places the business outside of its financial capacity. If yes, then the purchase order is forwarded within the company to seek authorization or approval at step 209. At 211 the step of attaching a note to the approval request indicating future covenant default is shown. Then the approval request is actually made at 216. If there is no future margin problem, then the purchase order may be processed at 232.

If step 230 is a no, at 220 then the executive can provide an explanation of why not. If the calculation step at 212 indicates that a margin covenant is at risk, then this can also be attached to the approval request to the executive of the business so that an evaluation can be made prior to issuing the purchase order. At 230 if the purchase order has been approved then it may be printed at 232 and sent to the supplier at 218.

It can now be appreciated how the present invention may be used. Firstly, the business is allowed to log onto the ASP and to the system of the present invention by being given access through the secure firewall by means of a password or the like. At this time the data extraction module will be initiated to go to the business records which comprises the electronic records of account of the business to extract the relevant information to ensure that the data in the system is current. As part of the sign on procedure, the connection will be established to permit the system to identify the business and to therefore recall and update the records that are specific to that business. As indicated previously, the system will be preprogrammed with the financial conditions for that enterprise, including, the operating parameters established by the chief financial officer or the like as well as the conditions which may be established by any capital provider.

Once the secure link is established and the data extraction is complete, then the system is ready for a new query from the enterprise. For example, the accounts payable department may wish to know if they can pay a particular account payable. The request is then made through a series of user interface screens to the system. The system will provide an answer and will most preferably also provide an indication of how close the proposed transaction will put the business to any of the financial capacity limits. Good results have been achieved when this is done by means of a coloured indicator. Thus, if the transaction is clear then the screen remains green; if the transaction places the business within say ten percent of the limit, then the colour will be changed to amber and if the transaction places the business outside of an limit then the colour can be changed to red.

It will be desirable to let the business, due to its own requirements to conduct so called red transactions from time to time. Thus, to permit this to happen, the system will require the information be entered a second time in the same manner. This will also reduce the likelihood that a false entry will be processed, in that with the second entry of the transaction request any errors contained in the first one will likely be corrected. The request for processing a red transaction will immediately cause a message to be sent to the necessary supervisors, which may include one or more of senior executives in the business itself and one or more executives at a capital provider such as a lender. The system will then be available for analysing a number of issues such as the risk inherent in the proposed transactions as calculated pursuant to various what if scenarios, the terms of an lending agreement in terms of default fees and the like and will then prompt a discussion of whether to modify the lending conditions to comprehend the specific default situation.

It will be appreciated by those skilled in the art that the foregoing description relates to preferred embodiments of the present invention and various modifications and variations are comprehended within the broad scope of the appended claims. Some of these have been disclosed above, while others will be apparent to those skilled in the art. For example, while reference has been made to certain types of financial capacity calculations, other could also be used in addition to or instead of the ones described herein, provided that the result in financial information relevant to the financial capacity of an enterprise.

We claim:

1. A computerized method of managing information relating to a financial capacity of a business having electronic records of financial accounts, the method comprising the steps of:
providing a software system for monitoring a cash position of the business, said software system including one or more predetermined limits defined by the financial capacity of the business;
permitting said software system to periodically connect to the electronic records to receive updated transaction information to calculate a current cash position;
calculating a cash position of the business in respect of a proposed transaction by the business;
calculating a permitted cash position based on said updated transaction information and said one or more limits defined by said financial capacity;
comparing the calculated cash position of the business after said proposed transaction to said permitted cash position; and
providing an indication of whether the proposed transaction will cause the business to fall outside of any of said limits defined by said financial capacity.

2. A computerized method of managing information relating to a financial capacity of a business as claimed in claim 1 wherein said step of providing an indication includes providing an electronic message to a specified business manager.

3. A computerized method of managing information relating to a financial capacity of a business as claimed in claim 1 wherein said step of providing an indication includes providing an electronic message to a specified party outside of the business.

4. A computerized method of managing information relating to a financial capacity of a business as claimed in claim 3 wherein said specified outside party includes one or more of a capital provider or a debt provider.

5. A computerized method of managing information relating to a financial capacity of a business as claimed in claim 1 wherein said software system connects to the electronic records and calculates a current cash position in response to a request for approval for said proposed transaction.

6. A computerized method of managing information relating to a financial capacity of a business as claimed in claim 5 further including the steps of authorizing the proposed transaction in the event the proposed transaction will not cause the business to fall outside of any of said limits defined by said financial capacity and recording the authorized transaction in the cash position of the borrower.

7. A computerized method of managing information relating to a financial capacity of a business as claimed in claim 6 wherein said step of calculating a permitted cash position includes calculating a permitted bank margin.

8. A computerized method of managing information relating to a financial capacity of a business as claimed in claim 6 wherein said step of calculating a permitted cash position includes one or more steps of calculating a permitted inventory margin and a permitted accounts receivable margin.

9. A computerized method of managing information relating to a financial capacity of a business as claimed in claim 6 wherein said step of calculating a permitted cash position of the business includes the step of calculating a permitted current ratio of the value of current assets to current liabilities.

10. A computerized method of managing information relating to a financial capacity of a business as claimed in claim 6 wherein said step of calculating a permitted cash position of the business further includes the step of calculating a projected cash flow after debt service ratio.

11. A computerized method of managing information relating to a financial capacity of a business as claimed in claim 6 further including the step of calculating a debt to equity ratio.

12. A computerized method of managing information relating to a financial capacity of a business as claimed in claim 6 further including the step calculating compliance with one or more lender covenants selected from the group of allowed capital expenditures, return on sales, EBITDA, Net profit, directors and officers remuneration, dividends, timely priority payments and shareholder remuneration.

13. A computerized method of managing information relating to a financial capacity of a business as claimed in claim 1 wherein said step of calculating said permitted cash position further includes the steps of calculating operating criteria.

14. A computerized method of managing information relating to a financial capacity of a business as claimed in claim 6 further including the steps of projecting future cash flow requirements over a predetermined period in light of said proposed transaction.

15. A computerized method of managing information relating to a financial capacity of a business as claimed in claim 14 wherein said step of projecting future cash flow requirements includes projecting expenses and income over the predetermined period having regard to previous years' expenses and incomes for an equivalent period to said predetermined period.

16. A computerized method of managing information relating to a financial capacity of a business as claimed in claim 15 wherein said step of projecting future cash flow requirements includes the step of comparing said future cash position to one or more lender covenants.

17. A computerized method of managing information relating to a financial capacity of a business as claimed in claim 14 wherein said step of calculating said cash disbursements includes the step of calculating payroll, deemed trusts, standing payments, taxes, loan payments, and contingencies.

18. A computerized method of managing information relating to a financial capacity of a business as claimed in claim 1 further including a step of varying one or more assumptions relating to said financial capacity and calculating a revised permitted cash position.

19. A computerized method of managing information relating to a financial capacity of a business as claimed in claim 1 further including the step of providing a data extraction module to permit the software system to extract appropriate financial information from the electronic records.

20. A computerized method of managing information relating to a financial capacity of a business as claimed in claim 6 wherein said step of authorization of said transaction further includes the step of marking a transaction document to certify payment approval for a recipient.

21. A computerized system for managing information relevant to a financial capacity of a business having electronic records of financial accounts, the system comprising:
a software platform for monitoring a cash position of the business, said software platform including one or more predetermined limits defined by the financial capacity of the business;
a communication connection between said software platform and said electronic records of account to permit updated transaction information to be provided to said software platform;
wherein said software platform further includes an actual cash position calculation module, a permitted cash position calculation module and a comparer to permit the two cash positions to be compared; and
a communication module for communicating whether the proposed transaction will cause the business to fall outside of any of said limits defined by said financial capacity.

22. A computerized system for managing information relating to a financial capacity of a business having electronic records of financial accounts as claimed in claim 21 wherein said communication module includes a graphical user interface which indicates whether the proposed transaction is permitted, denied, or allowed but brings the enterprise close to a financial capacity limit.

23. A computerized system for managing information relating to a financial capacity of a business having electronic records of financial accounts as claimed in claim 1 wherein said communication module further includes a notice generator to provide electronic notices to predetermined addressees of a request for a denied transaction.

24. A computerized system for managing information relating to a financial capacity of a business having electronic records of financial accounts as claimed in claim 21 further including a ‘what if’ scenario generator for permitting certain hypothetical events to be entered and evaluated by the software system.

25. A computerized system for managing information relating to a financial capacity of a business having electronic records of financial accounts as claimed in claim 21 further including a future cash position calculation module for evaluating future cash flow in light of a proposed transaction.

26. A computerized system for managing information relating to a financial capacity of a business having electronic records of financial accounts as claimed in claim 21 further including a marker for certifying approval of said proposed transaction on a payment record.
